(19) United States
(12) Patent Application Publication
(10) Pub. No.: US 2023/0375272 A1
(43) Pub. Date: Nov. 23, 2023

(54) BLAST FURNACE WITH SHAFT FEEDING OF HOT PROCESS GAS

(71) Applicant: PAUL WURTH S.A., Luxembourg (LU)

(72) Inventors: Nicolas MAGGIOLI, Thionville (FR); Gilles KASS, Sanem (LU); Klaus Peter KINZEL, Sandweiler (LU)

(21) Appl. No.: 18/027,488

(22) PCT Filed: Sep. 27, 2021
(86) PCT No.: PCT/EP2021/076530

§ 371 Date: Mar. 21, 2023

(30) Foreign Application Priority Data
Sep. 28, 2020 (LU) 102098

(51) Int. Cl. F27D 7/02; F27D 3/16; F27B 1/16; F27B 1/24; F27D 99/00

(52) U.S. Cl. CPC F27D 7/02; F27D 3/16; F27B 1/16; F27B 1/24; F27D 99/0073; F27D 2007/023; F27D 2003/166

(57) ABSTRACT

A shaft furnace, in particular a blast furnace, comprises includes an outer metal shell; a plurality of tuyeres arranged to inject hot blast into the shaft furnace; and means for injecting process gas in the shaft stack area, where the injector has a nozzle body with a peripheral wall extending along a longitudinal axis from a front portion, with at least one injection hole, to an opposite rear portion connected to a base member, where the nozzle body includes an inner gas channel for guiding process gas from an inlet port in the base member to the injection holes(s), nozzle body being mounted through an aperture in the metal shell in such a way that the front region with injection hole(s) is located on the inner side of the metal shell, whereas the rear portion is outside of the metal shell, and the base member includes a peripheral mounting portion configured for connecting the injector in a gas tight manner to a mounting unit surrounding the aperture in the metal shell.

### TECHNICAL FIELD

The present disclosure generally relates to the field of metallurgy and more specifically to the operation of shaft furnaces, and namely blast furnaces, wherein hot reducing gas is fed into the furnace shaft, in particular in the stack area.

### BACKGROUND

With the Paris Agreement and near-global consensus on the need for action on emissions, it is imperative that each industrial sector looks into the development of solutions towards improving energy efficiency and decreasing CO₂ output.

In this context, actors in the field of iron metallurgy have developed new approaches in order to reduce the environmental footprint of the blast furnace iron making route. Indeed, despite alternative methods, like scrap melting or direct reduction within an electric arc furnace, the blast furnace (BF) today still represents the most widely used process for steel production.

Amongst the approaches developed to reduce blast furnace CO₂ emissions, it has been proposed to introduce hot reducing gas, typically syngas (composed mainly of CO and H₂), directly into the shaft of the blast furnace. This is also known as “shaft feeding” and implies the introduction/supply of the hot reducing gas (syngas) through the furnace outer wall, above the hot blast (tuyere) level, i.e. above the bosh, and preferably within the gas solid reduction zone of ferrous oxide above the cohesive zone.

### BRIEF SUMMARY

The disclosure improves the feeding of hot reducing gas into the shaft of the blast furnace.

The present disclosre arises from the observation that although the concept of shaft feeding (i.e. introduction of hot process/reducing gas in the blast furnace shaft) is cited in many publications or patents, no industrial application has yet been implemented on a commercial blast furnace. In several publications, theoretical or experimental investigations of gas injection in the shaft of a blast furnace are described. In general, CFD simulations or experimental tests on small scale models are used to investigate the influence of different parameters on the gas penetration and distribution in a porous layered structure of coke and sinter/pellets as it exists in the upper part of a blast furnace. In general, the conclusions of these studies are that the penetration depth is rather limited and that the gas remains close to the blast furnace wall.

The present disclosure proposes a shaft furnace as as described herein.

According to the present disclosure, a shaft furnace, in particular a blast furnace, comprises:
a metal shell defining a furnace outer wall, preferably provided with cooling elements and/or refractory material;
a plurality of tuyeres arranged around the outer wall at a tuyeres level in order to inject hot blast into the shaft furnace;
means for injecting process gas, in particular hot reducing gas, into the shaft furnace at an injection level above the tuyeres level;
wherein the means for injecting process gas include at least one injector comprising:
a nozzle body with a peripheral wall extending along a longitudinal axis from a front portion, with at least one injection hole, to an opposite rear portion connected to a base member, wherein the nozzle body includes an inner gas channel for guiding gas from an inlet port in the base member to the injection holes(s);
the nozzle body being mounted through an aperture in the metal shell in such a way that the front region with injection hole(s) is located on the inner side of said metal shell, whereas the rear portion is outside of the metal shell; and
the base member comprising a peripheral mounting portion configured for connecting said injector in a sealed (gas tight) manner to a mounting unit surrounding the aperture in the metal shell (the mounting unit essentially positioned on the shell outer side).

The present disclosure permits increasing and adjusting the penetration depth of the injected process gas by providing an injector that protrudes inside the furnace. The process gas is typically hot reducing gas, e.g. a syngas mainly comprising CO and H₂. The injectors are preferably arranged to inject hot reducing gas in a stack area of the blast furnace. In practice the injectors as thus connected, outside the blast furnace, via appropriate piping, to a source of hot reducing gas (e.g. syngas (CO; H2).

The injector is provided with one or several injection holes (or nozzles) for the outlet of the hot gas, arranged in the front portion of the nozzle body, e.g. laterally and/or at the tip of the injector. The provision of injection holes on a single injector provides important flexibility with regards to the orientation of the gas injection. The gas distribution can thus be increased as the injector device is not limited to a single injection point.

In addition, the injector as such can be oriented either towards the center of the furnace or in a tangential direction (towards the internal shell circumference). The orientation in tangential direction helps creating a swirl flow in the blast furnace, which can increase the distribution of the gas and mixing with the ascending gas from the tuyere level.

The different combinations of number, angle of injectors together with the number, size, location and angle of the injection holes in each injector provides a huge flexibility to adapt the design of the injector to the given process conditions or the given blast furnace (small/large blast furnace).

Another benefit of the present disclosure is obtained by the injector's ability to be retrofitted easily on existing blast furnaces. The size of the injector is advantageously chosen in a way that it can be placed between 2 cooling elements (stave coolers—cast iron or copper, or other), by core drilling in-between the outer cooling channels of 2 adjacent cooling elements. Alternatively, it can be placed within one stave with adapted cooling channels. Taking advantage of the available quick stave exchange technologies today, this kind of intervention can also be realized in short blast furnace stoppages.

In embodiments, the aperture in the metal shell is surrounded by a sealed mounting unit that is adapted to cooperate with a mounting portion of the base member.

In embodiments, the base member is configured to support the injector body, i.e. the nozzle body is fixed to the base member at its rear portion. The mounting portion surrounds the nozzle body and is coupled, in a sealed manner, to the mounting unit. This allows a gas tight mounting of the injector to the metal shell. Proper gas tight mounting and injector design is particularly desirable since the process gas in the envisioned application contains CO and H₂, which will spontaneously inflame when leaking to the outside or may form an explosive atmosphere when mixing with air.

The mounting unit may include a sleeve surrounding the aperture and fixed in a sealed manner to the metal shell. The sleeve is provided with a first annular flange that cooperates with a second annular flange on the base member mounting portion.

In embodiments, base member comprises a cup-shaped outer element with a bottom wall surrounded by a side wall, the outer element comprising said the second annular flange; and an inner element received inside the outer element. The inner element has a first annular sealing surface cooperating with a second annular sealing surface of said outer member.

In embodiments, the inner element is ring-shaped and defines a central passage extending along said longitudinal axis, the central passage forming the inlet port for the process gas.

In embodiments, the inner element has an outer peripheral surface including the first sealing surface; and the side wall has an inner peripheral surface including the second sealing surface. The second sealing surface may be a frusto-conical surface tapering towards the bottom wall of the outer element; and the first sealing surface is a cooperating frusto-conical surface. Preferably, the first and second annular surfaces have matching/same cone angles.

The use of an inner and outer cone provides a safety feature that allows a gas tight connection of inner and outer members that can be easily dismounted, even if the probe is stuck inside the furnace either due to mechanical or thermal deformation or due to build-up or scaffolds. The outer member, not in contact with the furnace atmosphere can be removed and the inner part integral with the nozzle body can be either removed to the outside separately or, if the injector is completely deformed or has accretions sticking to it that do not allow its removal to the outside, it may be pushed with force inside the furnace. The inner member with injector nozzle will then be replaced by a spare part. This design thus provides a safe and reliable way to dismount, maintain and replace the injector. For this purpose, the outer dimensions of the nozzle body and inner member are, by design, inferior to the cross-section of the aperture in the metal shell, such that they can be forced into the furnace.

The easy dismantling device is also an advantage for routine inspections of the injecting area inside the furnace during maintenance stops of the blast furnace. The removal of the injector provides easy access for inspection and possibly cleaning/removal of scaffolds around the injection port.

In the blast furnace, the injector is typically arranged with its front portion engaged in the aperture in the metal shell, but also in an aperture in the cooling elements(s) and/or refractory material that covers the inner surface (or sometimes the outer surface) of the metal shell. The inventive nozzle is compatible with all kinds of cooling technologies, e.g. cooling panels/staves or cooling boxes and spraying. In general, the injector is positioned so that a certain length of the nozzle body front portion protrudes inside the furnace, i.e. protrudes with respect to the metal shell and/or the cooling element(s) front side and/or with respect to a ceramic layer formed on the cooling panel front side or on the metal shell. The protruding length may be adjusted depending on the applications and configuration of the injection holes. In some application, e.g. with axial protruding hole(s), the tip of the injector can be arranged to protrude only slightly, or flush, with the cooling elements front side/ceramic layer. This may be desirable in applications where penetration depth is not the major selection criteria, but more focus is put on the longevity and reduced maintenance of the injector.

In some embodiments, a protruding cover is arranged above the injector(s) and configured to protect the nozzle body front portion that protrudes inside the furnace from a descending burden material. Such protection of the injector nozzle body against abrasion by the descending burden material (sinter/pellets and coke) can be achieved for example by means of a steel shell (smooth or corrugated), optionally water cooled; a ceramic or refractory lining; or a build-up welding made of an anti-abrasive material. Alternatively, the upper surface of the nozzle body can be shaped to promote stagnation of the descending material. The injector may e.g. have a flattened upper surface with upward peripheral ribs for retaining the descending material.

Still a further possibility of protecting the protruding portion of the injector is to inject filling material above the injector to form a protective mass. This can be done by a feed channel arranged to extend from the region of the base member and to open in a front, upper region of the peripheral wall, through which filling material can be injected after mounting the injector in the furnace shell. The filling material is thus introduced once the injector is installed in the furnace wall, and accumulates above the injector as protective mass.

In general, the injector may be featured with instrumentation allowing thermal, mechanical and/or process monitoring. For example, the injector may include one or more thermocouples to monitor the temperature of the gas flow. It may further include wear detection sensors.

Conveniently, the injector parts are of generally axially symmetric shape, for ease of manufacturing and installation. The nozzle body and base member may typically have a circular cross-section. In embodiments, oblong or rectangular cross-sections could be envisaged, in particular for the nozzle body front portion, but it is desirable that the region of the interface between nozzle body and base member remains axially symmetric.

The above and other embodiments are recited in the appended dependent claims 2 to 25.

The present disclosure also concerns a process gas injector for a shaft furnace as disclosed herein and recited in any one of claims 1 to 25.

The injector comprises a nozzle body with a peripheral wall extending along a longitudinal axis from a front portion, with at least one injection hole, to an opposite rear portion connected to a base member, wherein the nozzle body includes an inner gas channel for guiding process gas from an inlet port in the base member to said injection holes(s). The nozzle body being is configured to be mounted trough an aperture in a shaft furnace metal shell in such a way that the front region with injection hole(s) located on the inner side of the metal shell, whereas the rear portion remains outside of the metal shell. The base member comprises a peripheral mounting portion configured for connecting said injector in a gas tight manner to a mounting unit surrounding the aperture (66) in the metal shell.

The present disclosure is an important addition to the technology of shaft feeding and finds for example application in the currently developed methods for the production of syngas based on reforming of hydrocarbon containing gases (coke oven gas, natural gas), or gas separation processes allowing to concentrate CO and H₂ in a gas stream to be reapplied after its heating in the blast furnace. The present disclosure will allow injecting significant quantities of hot reducing gas, resulting in significant reductions in coke consumption and CO₂ emissions. In this regard, shaft feeding is an important technology to further increase productivity, decrease operating costs, reduce coke consumption and CO₂ emissions in the blast furnace process.

### BRIEF DESCRIPTION OF THE DRAWINGS

The present disclosure will now be described, by way of example, with reference to the accompanying drawings, in which:

FIG. 1: is a principle view of a blast furnace equipped for shaft injection of hot reducing gas;

FIG. 2: is a principle cross-sectional view through the present injector mounted in the blast furnace;

FIG. 3: is a sketch illustrating a system for injection of hot reducing gas; and

FIG. 4: is a principle diagram of a protective cover for the injector in a) side view and b) front view.

### DETAILED DESCRIPTION

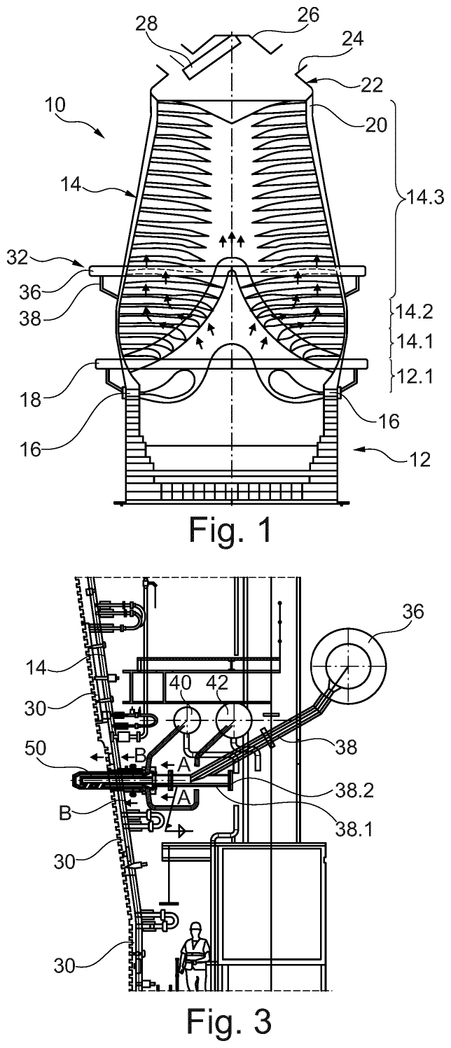

FIG. 1 schematically shows a blast furnace 10 which conventionally comprises a hearth 12 and a shaft-forming steel shell 14 extending vertically above the hearth 12. The upper zone 12.1 of the hearth wall contains the openings for tuyeres 16, which are used to introduce the hot blast into the furnace. In this tuyere band 12.1, the tuyeres 16 are circumferentially distributed around the furnace and fed with hot blast from a peripheral/annular bustle pipe 18. The shell 14 is conventionally divided in three zones: the bosh 14.1, the belly 14.2 and the stack 14.3. The throat 20 of the blast furnace is closed by a top cone 22 with offtakes 24 and a top ring 26. Although not shown, a top charging installation is arranged above the top cone 22 and serves the function of distributing blast furnace raw materials into the furnace. The top charging installation is preferably of the BELL LESS TOP ® type, the distribution chute 28 thereof being illustrated in FIG. 1.

The steel shell 14 constitutes the furnace outer wall. Its inner surface (i.e. towards the furnace interior) is generally covered with cooling panels 30 (or staves), as better seen in FIG. 3. Such cooling panels typically have a slab-like body made from steel or copper (alloy) with internal coolant channels through which a coolant (water) is circulated. The front side of the cooling panels 30 (i.e. facing the furnace interior) is also generally covered with a protective layer of steel blades inserts or refractory material (not shown).

Reference sign 32 in FIG. 1 designates a shaft injection system configured to introduce hot reducing gas into the shaft of the blast furnace, i.e. above the tuyeres level 12.1. The hot reducing gas is typically a syngas containing CO and H₂. Referring to FIG. 3, the shaft injection system 32 here comprises a plurality of injectors 50 (described in detail below) connected to a first peripheral duct 36 (similar to bustle pipe 18) that carries the syngas/process gas. In practice the peripheral duct is thus connected to a source of process gas (not shown). Each injector 50 is connected to duct 36 via an individual connector piping 38. The injectors 50 are preferably water cooled. Reference sign 40 designates a second peripheral duct that carries fresh cooling water for the injectors, whereas the cooling water flowing out from the injectors is collected via a third peripheral duct 42.

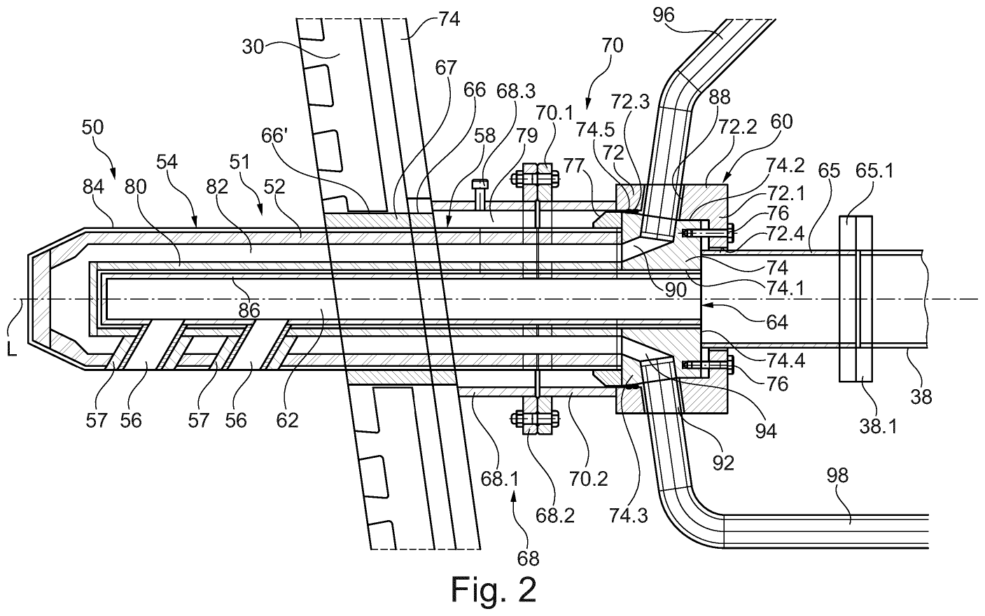

An embodiment of the fuel injector will now be described in detail with reference to FIG. 2. The injector 50 comprises a nozzle body 51 with a peripheral wall 52 extending along a longitudinal axis L from a front portion 54, with e.g. two injection holes 56, to an opposite rear portion 58 connected to a base member 60. The nozzle body 51 includes an inner gas channel 62 for guiding gas from an inlet port 64 in the base member 60 to the injection holes 56.

The nozzle body 51 is mounted trough an aperture 66 in the furnace shell 14 in such a way that the front region 54 with injection hole(s) is located inside the furnace, whereas the base portion 56 is outside the outer wall 14. The base member 60 is connected in a sealed manner to the outer wall 14.

Since the shell 14 is internally covered with cooling panels 30, a second aperture 66′ is formed in the cooling panels (or adjacent cooling panels) in axial continuation of the first aperture 66. The injector can thus be properly arranged with the front portion inside the furnace. The nozzle body extends through the apertures in the shell 14 and cooling panel 30 and protrudes from the cooling panels inside the furnace.

The second aperture 66′ can be carried out in a single cooling panel or at the junction between two cooling panels, in body portions where there is no internal coolant channels.

For ease of installation and sealing purposes, a guide sleeve 67 (made from steel, ceramic material or suitable metal alloys) can be arranged to extend in the two apertures 66, 66′. The guide sleeve 67 has an outer diameter corresponding to the diameter of the two apertures 66, 66′ and a length corresponding to the distance from the cooling plate front side to the shell's 14 outer side. The inner diameter of the guide sleeve 67 matches the outer diameter of the nozzle body 51.

The aperture 66 in the outer wall 14 is surrounded by a sealed mounting unit 68 that is adapted to cooperate with a mounting portion 70 of the base member 60. The mounting unit 68 includes a sleeve 68.1 (pipe section) surrounding aperture 66 and sealingly welded to the outer surface of shell 14. The sleeve 68.1 extends away from the shell 14 generally along axis L and has a first annular flange 68.2 surrounding its inlet, which is intended to cooperate with a second annular flange 70.1 of the base member mounting portion 70. In the present text, the terms ‘sealed’ or ‘sealingly’ imply a gas tight junction/assembly.

The base member 60 includes a cup-shaped outer element 72 with a bottom wall 72.1 surrounded by a side wall 72.2; and an inner element 74 is received inside the outer element 72. The outer element 72 is oriented such that its recess containing the inner element 74 faces the injector body 51. The mounting portion 70 is arranged in axial continuation of the side wall 72.2 towards the mounting unit 68. It comprises a sleeve portion 70.2 welded at one end to the outer element and provided at the other end with the second annular flange 70.1.

The inner element 74 is ring-shaped and defines a central passage 74.1 extending along the longitudinal axis L, said central passage forming said inlet port 64 for the process gas. The ring shaped inner element 74 has a generally conical cross-section with an outer, peripheral surface 74.2 opposite the inner surface 74.1, as well as radially extending, front and rear surfaces 74.3, 74.4, turned respectively towards the injector body 51 and outer element bottom wall 72.1.

The peripheral surface 74.2 of the inner element includes a first annular sealing surface 74.5 that cooperates with a facing, second annular sealing surface 72.3 on the inside of the side wall 72.2. In this embodiment, the first and second sealing surfaces 74.5, 72.3 are designed as cooperating frusto-conical surfaces providing a metal-to-metal gas tight seal. An additional sealing can be done with O-ring seals type, or other metallic seals. The second sealing surface 72.3 tapers towards the bottom wall 72.1, so that pushing the inner member 74 inside the outer member 72 increases the contact pressure at the sealing surfaces.

Preferably, the cone angle of the first annular surface 74.5 is preferably the same as that of the second annular surface 72.3.

The inner member 74 is fixed in the outer member 72 by means of screws 76, which are engaged through the bottom wall 72.1 of the outer member 72.

The nozzle body 51 further includes an inner tube 80 extending axially from the base member 60 towards the front region, in axial continuation of the central passage 74.1. The inner tube 80 is configured to guide process gas from the inlet port 64 to the injection holes.

As shown in FIG. 2, the inlet port 64 includes a connection duct 65 that is fixed on the rear surface 74.4 of the internal member and surrounds passage 74.1. The connection duct 65 extends in an opening 72.4 through bottom wall 72.1 and comprises a coupler, e.g. an annular flange 65.1, for coupling to a corresponding flange 38.1 of a feed branch 38 communicating with the peripheral pipe 36 supplying the hot reducing gas. Although not shown, connection duct 65 and feed branch 38 may be provided with a refractory lining.

The components of the nozzle body 51 and base member 60 may generally be made from steel or steel-alloy or metallic-alloy. In embodiments, the outer wall 52 and inner tube 80 may be made from copper or copper alloy.

As can be seen, both the peripheral wall 52 and inner tube 80 are configured as tubular members closed at the front (except for the injection holes) and open at the rear, where they are supported by the inner member 74. The term ‘supported’ here means that the rear ends of the tubes 52 and 80 are fixed to the inner member 74, e.g. by welding. Since the inlet of inner tube 80 surrounds the central passage 74.1 and the peripheral wall 52 surrounds the inner tube 80, a closed annular gap 82 is formed between the two tubes.

With this double walled configuration, the injection holes 56 are formed by small pipe sections 57 extending from the inner tube 80 to the peripheral wall, as shown in FIG. 2.

In this variant, the injection holes 56 are inclined forward, thus towards the center of the shaft. In general, an injection hole can be configured to inject process gas axially (opening in the tip of the injector body) or laterally, either forward as shown, or downwards (perpendicularly to axis L), or even tangentially (i.e. along the inner shell circumference) to produce a swirl effect.

Reference sign 77 designates a centering ring fixed to the front side 74.3 of the inner ring. Its dimensions (diameter/thickness) essentially correspond to those of guide sleeve 67. Hence the thickness of centering ring 77 corresponds to the annular space between the outer wall and sleeve 70.2.

The fuel injector 50 is exposed to substantial heat inside the furnace. Therefore, a heat protective layer 84, e.g. made from ceramic material or steel-alloy or hard-facing, are formed on the outer surface of peripheral wall 52. An insulating layer 86, preferably ceramic or refractory based, protects the inner surface of inner tube 80. An intermediate layer of metallic or insulating material can be arranged between tube 80 and insulating layer 86. Preferably, copper based parts (tubes 52 and 80) and steel layers (intermediate layer and outer layer 84) are metallurgically bound together via a diffusion layer.

Preferably, water can be circulated in the annular gap 82 formed in the nozzle body 51. The gap 82 can be foreseen with guiding elements to avoid stagnant zones and to ensure sufficiently high water speed allowing to efficiently protect the injector from the heat of the blast furnace on the one hand, and the hot syngas on the other hand. Therefore a coolant inlet channel is formed in the base member 60, which comprises an inlet guide passage 88 in the side wall 72.2 of the outer element 72 (larger than the coolant pipe 96) and a bent passage 90, with threaded inlet section, leading from the first sealing surface 74.5 to an opening in the front face 74.3 of the inner element 74 that communicates with the annular gap 82.

A coolant outlet channel comprises an outlet guide channel 92 in the side wall 72.2 of the outer element 72, spaced/opposite from the inlet section 88, and a bent passage 94, with threaded inlet section, leading from the first sealing surface 74.5 to an opening in the front face 74.3 of the inner element 74 that communicates with the annular gap 82.

Additional sealing elements can be arranged at the outer surface of the inlet and outlet channels with the outer wall 72.2.

A first water pipe 96 is fitted into inlet guide passage 88 and further extends into bend passage 90, where it is sealingly threaded in the inlet section. At the opposite end the first water pipe 96 includes a coupler (not shown) for direct or indirect connection to peripheral duct 40. A second water pipe 98 is fitted into inlet section 92 and further extends into bend passage 94 where it is sealingly threaded in the inlet section. At the opposite end the second water 98 pipe includes a coupler (not shown) for direct or indirect connection to peripheral duct 42. The guide passages 88 and 92 have a cross-section slightly larger than the outer diameters of coolant pipes 96, 98.

Reference sign 68.3 indicates a filling nipple through which grouting material, insulating material or similar material can be injected into the void 79 between the nozzle body 51 and sleeve 68.1 (on the furnace outer side), thus reducing leakage risks and/or filling with dust and the like.

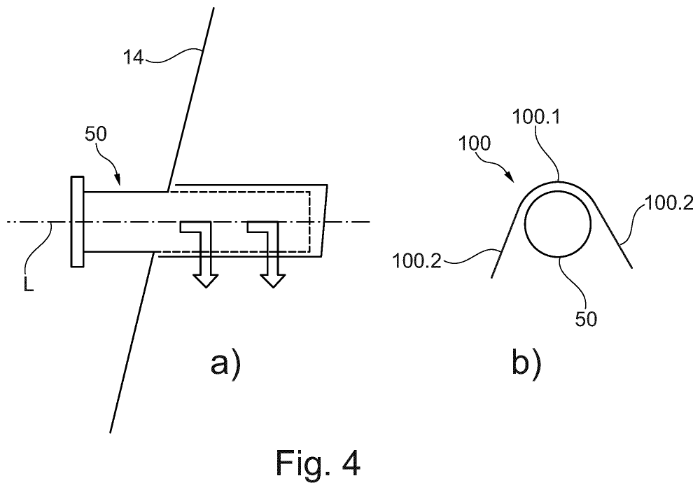

In embodiments, a protruding cover may be arranged above the injector(s) and configured to protect the nozzle body front portion that protrudes inside the furnace from a descending burden material. Such protection of the injector nozzle body against abrasion by the descending burden material (sinter/pellets and coke) can e.g. be achieved by means of a steel shell, smooth or corrugated. The principle of this protruding cover 100 is shown in FIG. 4 and forms a kind of cap extending in the injector's longitudinal direction L. It cover the protruding length of the injector (shown in dashed lines) As can be seen, the cover 100 is a curved steel profile section, more particularly having an inverted, rounded V-shape. The apex 100.1 of the V is above the injector 50 and the two branches 100.2 extends on both lateral sides of the injector 50, optionally even below the injector. The cover 100 can be liquid cooled, directly or indirectly. Coolant channels can e.g. be arranged on the lower side of the shell.

It remains to be noted that the connection piping 38 may include an elbow 38.1 with a maintenance and inspection port 38.2 provided within the rear part of the elbow 38.1, its longitudinal center axis corresponding to the injector's longitudinal axis L. A cover, a view glass and/or a camera is/are removably attached to the inspection port 38.2. A camera and a view glass can be used simultaneously, for example by using an appropriately placed beam splitter. As at shaft level, contrary to the tuyere level, the inside of the blast furnace is dark, the camera preferably is a thermal and/or infrared camera and/or an additional light source can be provided.

1. A shaft furnace, in particular a blast furnace, comprising:
a metal shell defining a furnace outer wall;
a plurality of tuyeres arranged around the metal shell at a tuyeres level in order to inject hot blast into the shaft furnace;
means for injecting process gas, in particular hot reducing gas, into the shaft furnace at an injection level above said tuyeres level;
wherein said means for injecting hot process gas include at least one injector, said injector comprising:
a nozzle body with a peripheral wall extending along a longitudinal axis from a front portion, with at least one injection hole, to an opposite rear portion connected to a base member, wherein the nozzle body includes an inner gas channel for guiding process gas from an inlet port in the base member to said injection holes(s);
said nozzle body being mounted trough an aperture in said metal shell in such a way that the front region with injection hole(s) is located on the inner side of said metal shell, whereas said rear portion is outside of said metal shell; and
wherein said base member comprises a peripheral mounting portion configured for connecting said injector in a gas tight manner to a mounting unit surrounding said aperture in said metal shell.

2. The shaft furnace according to claim 1, wherein said base member is configured to support said injector body; and
said peripheral mounting portion surrounds said nozzle body over a part of its rear portion.

3. The shaft furnace according to claim 2, wherein said mounting unit includes a sleeve surrounding said aperture and fixed in a sealed manner to the metal shell; the sleeve being provided with a first annular flange that cooperates with a second annular flange on said peripheral mounting portion of said base member.

4. The shaft furnace according to claim 3, wherein said base member comprises:
a cup-shaped outer element with a bottom wall surrounded by a side wall, said outer element comprising said second annular flange; and
an inner element received inside the outer element;
said inner element having a first annular sealing surface cooperating with a second annular sealing surface of said outer member.

5. The shaft furnace according to claim 4, wherein said inner element is ring-shaped and defines a central passage extending along said longitudinal axis, said central passage forming said inlet port for the process gas.

6. The shaft furnace according to claim 4, wherein said inner element has an outer peripheral surface including said first sealing surface; and said side wall has an inner peripheral surface including said second sealing surface.

7. The shaft furnace according to claim 6, wherein second sealing surface is a frusto-conical surface tapering towards said bottom wall of the outer element; and the first sealing surface is a cooperating frusto-conical surface.

8. The shaft furnace according to claim 1, wherein said nozzle body includes an inner tube extending axially from the base member towards the tip, in axial continuation of said central passage, said inner tube being configured to guide process gas from said inlet port to said injection holes.

9. The shaft furnace according to claim 8, wherein a closed annular gap is formed between said inner tube and peripheral wall; and said base member comprises a coolant inlet channel and a coolant outlet channel arranged to supply a coolant fluid to the annular gap, respectively withdraw coolant fluid therefrom.

10. The shaft furnace according to claim 9, wherein said coolant inlet channel comprises an inlet guide channel in said side wall of said outer element and a bent passage leading from the first sealing surface to an opening in a front side of said inner element and communicating with said annular gap; and said coolant outlet channel comprises an outlet guide channel in said side wall of said outer element and a bent passage leading from the first sealing surface to an opening in said front side of said inner element and communicating with said annular gap.

11. The shaft furnace according to claim 10, wherein a first cooling pipe is sealing mounted in the coolant inlet channel and a second cooling pipe is sealing mounted in the coolant outlet channel, each of said first and second cooling pipes having a coupler for connection to respective coolant supply and collecting ducts.

12. The shaft furnace according to claim 1, wherein said nozzle body is further inserted through an aperture in a cooling element or adjacent cooling elements or ceramic/refractory lining, whereby the front portion protrudes by a predetermined length from a hot side of the cooling element(s), from a ceramic layer covering the cooling element front side, resp. from said ceramic/refractory lining.

13. The shaft furnace according to claim 1, wherein a protruding cover is arranged above the injector(s) and configured to protect the nozzle body front portion that protrudes inside the furnace from a descending burden material.

14. The shaft furnace according to claim 1, wherein said injection holes are configured to permit process gas injection generally along the longitudinal axis and/or transversally thereto; and/or wherein at least some injection holes-are arranged laterally in the front portion to inject gas downstream in the furnace or tangentially.

15. (canceled)

16. The shaft furnace according to claim 1, wherein said injector is arranged through said metal shell so that its longitudinal axis is directed generally towards a center of said furnace or is tangentially oriented.

17. The shaft furnace according to claim 1, wherein said injector comprises a process gas feed branch that is connected at one end to a rear face of said inner member, surrounding said central passage, said feed branch extending through an opening in said outer member bottom wall, and comprising at its other end a coupler.

18. The shaft furnace according to claim 16, wherein said means for injecting process gas include a peripheral pipe surrounding the metal shell, each injector being connected to said peripheral duct by an individual feed pipe connected to the coupler of the injector feed branch.

19. The shaft furnace according to claim 1, wherein said peripheral wall is cladded with an outer heat protection layer and/or said inner tube is provided with an inner heat protection layer; and/or wherein said peripheral wall is covered with anti-abrasion protection like welding, abrasion resisting material.

20. (canceled)

21. The shaft furnace according to claim 1, wherein said injector includes one or more thermocouples and/or wear detectors.

22. The shaft furnace according to claim 1, wherein an upper surface of said nozzle body is shaped to promote stagnation of descending material, in particular by way of a flattened upper surface with upward peripheral ribs.

23. The shaft furnace according to claim 1, wherein said injector includes a feed channel for filling material opening in a front, upper region of said peripheral wall.

24. The shaft furnace according to claim 1, wherein outer dimensions of said nozzle body and said inner member are, by design, inferior to the cross-section of said aperture in said metal shell, such that they can be forced into the furnace.

25. The shaft furnace according to claim 1, wherein said mounting unit or mounting portion include a filling nipple for injecting grouting material, insulating material or similar material in an annular space surrounding said peripheral wall.

26. (canceled)

27. A process gas injector for a shaft furnace comprising
a nozzle body with a peripheral wall extending along a longitudinal axis from a front portion, with at least one injection hole, to an opposite rear portion connected to a base member, wherein the nozzle body includes an inner gas channel for guiding process gas from an inlet port in the base member to said injection holes(s);
wherein the nozzle body being is configured to be mounted trough an aperture in a shaft furnace metal shell in such a way that the front region with injection hole(s) located on the inner side of the metal shell, whereas the rear portion remains outside of the metal shell; and
wherein the base member comprises a peripheral mounting portion configured for connecting said injector in a gas tight manner to a mounting unit surrounding the aperture in the metal shell.
